(19) United States
(12) Patent Application Publication
(10) Pub. No.: US 2025/0111611 A1
(43) Pub. Date: Apr. 3, 2025

(54) Generating Virtual Representations Using Media Assets

(71) Applicant: Apple Inc., Cupertino, CA (US)

(72) Inventors: Abhishek Bisht, Fremont, CA (US); Pramod Srinivasan, Sunnyvale, CA (US)

(21) Appl. No.: 18/827,221

(22) Filed: Sep. 6, 2024

Related U.S. Application Data
(60) Provisional application No. 63/586,593, filed on Sep. 29, 2023.

(51) Int. Cl. G06T 19/00; G06T 15/04

(52) U.S. Cl. CPC G06T 19/00; G06T 15/04

(57) ABSTRACT

Generating a 3D representation of a subject includes obtaining sensor data of a subject. Media assets comprising the subject can be obtained from a digital asset library. A visual artifact for the subject can be generated from the media assets and used, along with the sensor data, to generate one or more virtual representations of the subject. Visual artifacts include textural and/or geometric characteristics of the visual appearance of the subject and are derived from image data in the media assets.

### BACKGROUND

Computerized characters that represent users are commonly referred to as avatars. Avatars may take a wide variety of forms including virtual humans, animals, and plant life. Existing systems for avatar generation tend to inaccurately represent the user, require high-performance general and graphics processors, and generally do not work well on power-constrained mobile devices, such as smartphones or computing tablets.

Sometimes, difficulties arise in generating a realistic looking avatar because the avatar is based on data captured at a particular time. Accordingly, improvements are needed for avatar generation.

### BRIEF DESCRIPTION OF THE DRAWINGS

FIG. 1 shows a flow diagram of a technique for generating subject personas and accessories, according to some embodiments.

FIG. 2 shows a flowchart of a technique for supplementing virtual representation data with media content, according to one or more embodiments.

FIG. 3 shows a diagram of a technique for determining geometric virtual representation data, in accordance with some embodiments.

FIG. 4 shows a flowchart of a technique for predicting joint locations based on derived back data, in accordance with some embodiments.

FIG. 5 depicts an example network diagram for sharing digital assets, in accordance with one or more embodiments.

FIG. 6 shows, in block diagram form, a simplified system diagram according to one or more embodiments.

FIG. 7 shows, in block diagram form, a computer system in accordance with one or more embodiments.

### DETAILED DESCRIPTION

This disclosure relates generally to techniques for enhanced enrollment for generating virtual representations of subjects. More particularly, but not by way of limitation, this disclosure relates to techniques and systems for using media capturing image data of a subject to enhance a virtual representation of the subject.

This disclosure pertains to systems, methods, and computer readable media to generate a virtual representation of a subject by capturing sensor data during an enrollment process and additionally using media content comprising the user to supplement the sensor data for generating the virtual representation. In some embodiments, the virtual representation is generated to present an accurate or honest representation of the subject. During an enrollment process, a user may utilize a personal device to capture one or more images or other sensor data directed at the user from which enrollment data may be derived. In some cases, the sensor data captured during the enrollment process may be enhanced by consideration of additional media items having the user, such as stored images. Further, the appearance of the user at the time of enrollment may not be an accurate representation of the typical appearance of the user, for example due to temporary conditions such as a scar or other skin condition, clothing providing substantial coverage of the face or other parts of the body, or the like.

Embodiments described herein generate virtual representations of a subject by capturing sensor data of a subject during an enrollment process. In addition, the device may obtain digital assets having the subject, either locally or on remote storage. Modern consumer electronic devices have enabled users to a mass considerable amounts of digital assets (e.g., images, videos, etc.). These digital assets may be tagged as having particular individuals. For example, facial recognition may be used to detect digital assets comprising the user. Embodiments herein may leverage these digital assets to obtain additional data from which alternate, yet still accurate, virtual representations of the user may be generated.

In some embodiments, the digital assets comprising the user may be processed to extract visual artifacts of the user. Visual artifacts of the user may include, for example, textural components such as clothing, makeup, or the like. Further, visual artifacts may include geometric artifacts such as hairstyles, large jewelry, or other components which have a geometric component. In some embodiments, these visual artifacts may be used as input into a persona network to generate the virtual representation of the user. Additionally, or alternatively, these visual artifacts may be incorporated into an accessory library from which a user may alter accessories or other components of their virtual representation in a manner that depicts a realistic version of the subject.

In some embodiments, the digital assets may be used to supplement the sensor data captured during enrollment when the sensor data is insufficient. For example, a determination may be made that the sensor data fails to satisfy one or more quality metrics. For example, a portion of the user may not be well captured by the sensor data. Rather, image data of this portion of the user may be identified in the digital assets and supplemented into the persona network to generate the virtual representation.

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed embodiments. In this context, it should be understood that references to numbered drawing elements without associated identifiers (e.g., 100) refer to all instances of the drawing element with identifiers (e.g., 100a and 100b). Further, as part of this description, some of this disclosure's drawings may be provided in the form of a flow diagram. The boxes in any particular flow diagram may be presented in a particular order. However, it should be understood that the particular flow of any flow diagram is used only to exemplify one embodiment. In other embodiments, any of the various components depicted in the flow diagram may be deleted, or the components may be performed in a different order, or even concurrently. In addition, other embodiments may include additional steps not depicted as part of the flow diagram. The language used in this disclosure has been principally selected for readability and instructional purposes and may not have been selected to delineate or circumscribe the disclosed subject matter. Reference in this disclosure to “one embodiment” or to “an embodiment” means that a particular feature, structure, or characteristic described in connection with the embodiment is included in at least one embodiment, and multiple references to “one embodiment” or to “an embodiment” should not be understood to refer necessarily to the same embodiment or to different embodiments.

It should be appreciated that in the development of any actual implementation (as in any development project), numerous decisions must be made to achieve the developers' specific goals (e.g., compliance with system and business-related constraints) and that these goals will vary from one implementation to another. It should also be appreciated that such development efforts might be complex and time-consuming but would nevertheless be a routine undertaking for those of ordinary skill in the art of image capture having the benefit of this disclosure.

The term “digital asset” (DA) refers to data/information which is bundled or grouped in such a way as to be meaningfully rendered by a computational device for viewing, reading, and/or listening by a person or other computational device/machine/electronic device. Digital assets can include media items such as photos, recordings, and data objects (or simply “objects”), as well as video files and audio files. Image data related to photos, recordings, data objects, and/or video files can include information or data necessary to enable an electronic device to display or render images (such as photos) and videos. Audiovisual data can include information or data necessary to enable an electronic device to present videos and content having a visual and/or auditory component.

For purposes of this application, the term “persona” refers to a virtual representation of a subject that is generated to accurately reflect the subject's physical characteristics, movements, and the like.

For purposes of this application, the term “copresence environment” refers to a shared extended reality (XR) environment among multiple devices. The components within the environment typically maintain consistent spatial relationship to maintain spatial truth.

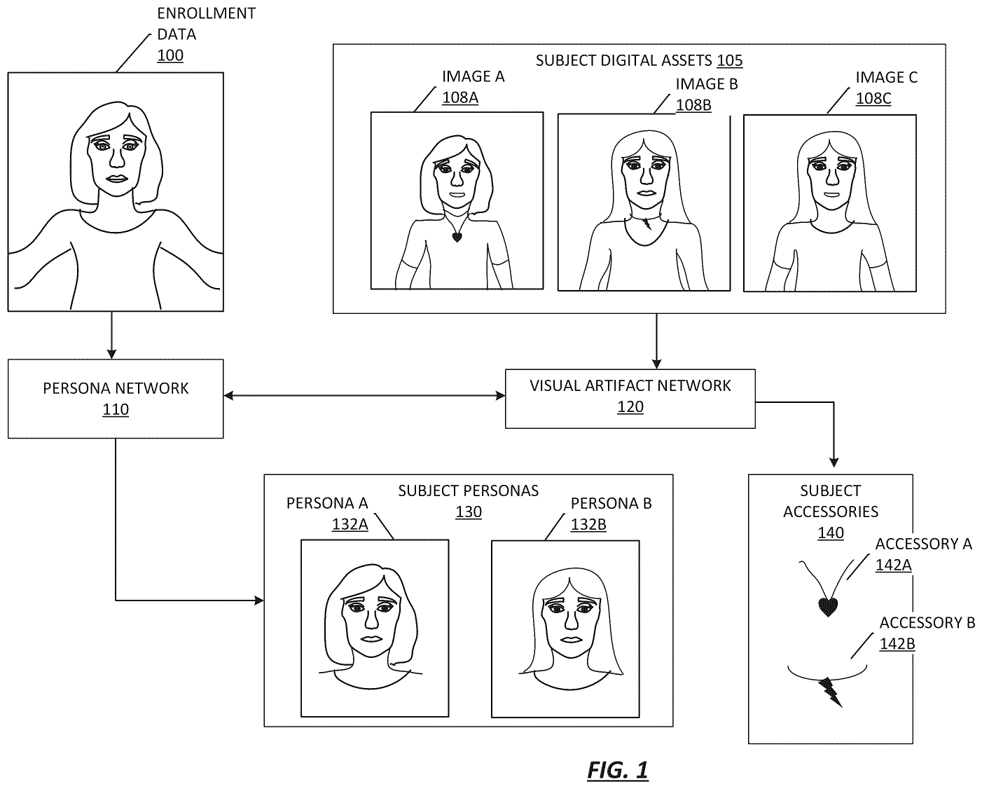

Turning to FIG. 1, a flow diagram is shown for generating subject personas and accessories, according to some embodiments. For purposes of explanation, the various processes are depicted and described as being performed by particular components. However, it should be understood that the various actions may be performed by alternate components. Further, some actions may be performed simultaneously, and some may not be required, or others may be added.

The flow diagram begins with enrollment data 100. According to one or more embodiments, enrollment data 100 may include sensor data captured during an enrollment process, from which a virtual representation of the subject captured in the enrollment data is derived. The enrollment data may include, for example, image data and depth data. The image data may be captured by one or more cameras facing the user capturing one or more images of the subject. In some embodiments, one or more images may be captured of the user performing one or more expressions, and may be captured from one or more points of view in relation to the subject. The depth data may be captured by one or more depth sensors captured coincident with the image data. The depth data may indicate a relative depth of the surface of the subject from the point of view of the device capturing the sensor data.

The enrollment data 100 is applied to a persona network 110 to generate one or more subject personas 130. According to one or more embodiments, the persona network 110 may use the enrollment data 100 to predict geometric characteristics and texture characteristics of the user such that an accurate representation of the subject in the form of one or more subject personas 130 can be generated. For example, the persona network 110 may utilize the enrollment data, including image data and depth data, to determine a geometric representation of the subject such as in the form of a 3D mesh, a texture, and the like. In some embodiments, other characteristics may be determined during enrollment to enhance the persona in a virtual environment, such as a copresence environment. For example, a skeleton may be determined comprising locations of individual joints, along with the relationship between the joints. The determination of the skeleton may be performed by the persona network 110 or by another network. The skeleton may be used to drive the persona during runtime to cause the persona to move in a manner that is an accurate representation of the movements of the subject.

According to one or more embodiments, the persona network 110 additionally considers visual artifacts from subject digital assets 105. That is, the enrollment data 100 may be supplemented with additional data derived from digital assets comprising the subject. Digital assets (DAs) may include media content such as image data, video data, or the like. Digital assets may be in the form of 2D or 3D image data, and may include or be stored with metadata indicative of context related to the image, such as people or objects detected in the image or otherwise identified as being present in the image. The digital assets may be obtained from a variety of sources. For example, in different scenarios, DAs may be stored locally, at a server, or a combination thereof. Accordingly, the DAs may be processed locally to identify DAs having the subject. Alternatively, the DAs may be requested from a remote source such as a separate client device, a server, or the like. In some embodiments, an identity of the subject in the enrollment data 100 may be determined or obtained. For example, if the enrollment data is performed during an enrollment process for a particular user account, that user account can be used to identify digital assets comprising the user associated with the user account. Alternatively, unique identifying information for the subject may be derived from the enrollment data 100 and may then be used to identify a subset of digital assets having the subject, for example using face recognition technology or the like. In this example, subject digital assets 105 include three images, including image A 108A, image B 108B, and image C 108C. According to one or more embodiments, each of image A 108A, image B 108B, and image C 108C may be determined to include the subject. As shown, each of image A 108A, image B 108B, and image C 108C may include the subject captured at different times, or in different contexts. As such, the digital assets may provide additional contextual data as to the visual characteristics of the subject in enrollment data 100. According to one or more embodiments, the digital assets utilized by the visual artifact network 120 may be selected based on other considerations, such as a quality determination of the digital assets, whether the digital assets include a portion of the subject for which insufficient enrollment data 100 is available, or the like.

In some embodiments, the visual artifact network 120 may be configured to generate visual artifacts used to supplement the enrollment data 100 for generated subject personas 130 by the persona network 110. For example, the visual artifact network 120 may generate data corresponding to portions of the subject for consideration by the persona network 110. In some embodiments, the visual artifacts may include portions of the subject which are not well captured by the enrollment data 100. As such, the visual artifacts provided by the visual artifact network 120 may be provided upon request from a preprocessing process for the persona network 110 determining a health score or other similar quality metric for the enrollment data 100 or portions of the enrollment data 100. The visual artifact may determine a 2D or 3D representation of the subject, or a portion of the subject based on one or more images comprising the subject or the portion of the subject. For example, several images of the side of a user's face may be used to supplement the enrollment data if the enrollment data of the particular side of the user's face is unavailable. Additionally, in the example shown, based on the subject's different hair styles in image B 108B and image C 108C of subject digital assets 105, the different hairstyles may be extracted by visual artifact network 120 and provided to persona network 110. In some embodiments, this additional data can be used to generate an alternative persona. As shown here, the hairstyle in persona A 132A matches the hairstyle depicted in the enrollment data 100, while the hairstyle in persona B 132B is generated based on the hairstyle shown in image B 108B and image C 108C. The hairstyle may be generated by the persona network 110 by fitting the image data of the hairstyle to the geometric representation of the subject's head, for example.

In some embodiments, the visual artifact network 120 may additionally use the subject digital asset 105 to build a wardrobe or set of accessories which a user can use to supplement or further personalize the persona. Example accessories may include jewelry, clothing, hats or other headwear, scarves, or the like. As shown here, the visual artifact network may use object detection in the subject digital assets to identify accessories, clothing items, or other objects which are shown to be worn by the subject. The visual artifact network 120 may be trained to detect these items and generate subject accessories in a form that may be used to augment or supplement one or more subject personas. In this example, visual artifact network 120 is shown as having generated accessory A 142A as a necklace being worn in image A 108A, and accessory B 142B as a necklace being worn in image B 108B. The accessories may be generated by detecting objects in the digital assets, extracting the objects from the digital assets, and transforming the objects from image data to texture data or another format which can be used to supplement a subject persona. As an example, the persona accessories may be generated in the form of a texture to overlay a portion of the geometry of the virtual representation of the subject, a three dimensional component to replace or augment the geometry of the virtual representation of the person, or the like. Although FIG. 1 illustrates subject accessories 140 as only including objects, embodiments are not so limited. In some embodiments, other features of the user's appearance detected from subject digital assets 105 that are not objects can be included in subject accessories 140. For instance, the hairstyle in persona B 132B can be included in subject accessories 140 for the user to select, should the user desire to have that hairstyle instead of the hairstyle in her enrollment image, e.g., the hairstyle in persona A 132A.

In some embodiments, the persona network 110 can provide data about the subject to the visual artifact network to facilitate transforming the image data into the form of a texture or geometry. For example, using the geometric properties of the subject as captured by persona network 110, the visual artifact network 120 can use one or more images having a particular accessory to generate a texture of the accessory from the digital assets where the subject is wearing the accessory. As such, the geometry information from the enrollment data 100 can be used to infer a geometry of the same subject in subject digital assets 105 to extract and transform accessories. Accordingly, a user can modify one of the subject personas 130 to wear a necklace or other accessory that would actually be worn by the user, thereby enhancing the ability to provide an accurate virtual representation of the user that is different from the appearance of the user captured during enrollment.

In another example, the persona network 110 can use digital assets captured after the enrollment data to enhance the subject personas 130 to maintain an accurate representation of the subject. For example, if new physical characteristics of the subject become apparent in the subject digital assets, the visual artifact network 120 can extract those physical characteristics and feed them into the persona network 110 to provide additional or revised subject personas.

Although the enrollment data is shown of the subject's face and upper torso, in some embodiments, other parts of the subject may be captured during enrollment such as the subject's hands or arms. For example, in an XR environment, and in particular in a copresence environment, the subject may be represented interacting with objects using a virtual representation of the user's hands. To maintain spatial truth and ensure accurate representation, the accuracy of the virtual representation of the hands and arms are important. However, the hands or arms may be covered at the time of enrollment. In some embodiments, the persona network may obtain hand or arm information extracted from the subject digital assets 105 by the visual artifact network 120. The image data can then be transformed into texture and/or geometric information by the visual artifact network 120 and used to enroll the hands for subject personas 130.

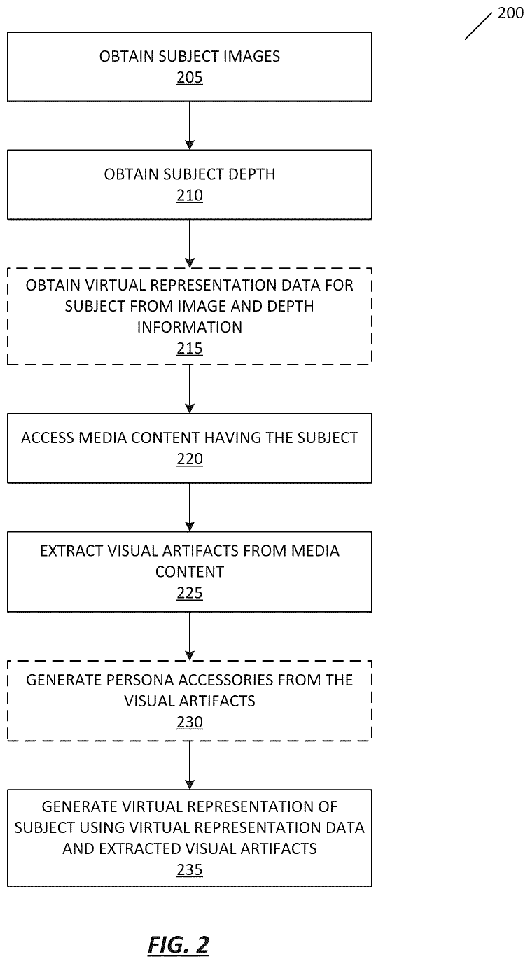

Turning to FIG. 2, a flow diagram is presented depicting a technique for generating a virtual representation of a subject, in accordance with one or more embodiments. For purposes of explanation, the following steps will be described in the context of FIG. 1. However, it should be understood that the various actions may be performed by alternate components. In addition, the various actions may be performed in a different order. Further, some actions may be performed simultaneously, and some may not be required, or others may be added.

The flowchart begins at block 205, where image data of the subject is obtained. In some embodiments, the image data may be captured, for example, during an enrollment period in which a user utilizes a personal device to capture an image directed at the user's face from which enrollment data may be derived for rendering avatar data associated with the user. In some embodiments, additional image data may be captured, such as of the subject's hands or arms. The image data may be captured by one or more cameras on a user device. For example, the user may enroll on a device that the user will use in an XR environment, such as a head mounted device. Alternatively, the subject may enroll on a separate device communicably connected to the head mounted device, such as a mobile device, desktop computer, or the like.

The flowchart continues to block 210, where depth data may be obtained corresponding to the images captured at 205. In some embodiments, depth sensor data may be captured by one or more depth sensors coincident with the images captured at block 205. The depth sensor data may indicate a relative depth of the surface of the subject from the point of view of the device capturing the image/sensor data. In some embodiments, the image data may include depth, or the depth may be derived from the image data. For example, multiple cameras, such as a stereo camera system, may be used to capture images of the subject, from which depth can be determined. As another example, the image data may be captured at least in part by a depth camera which provides depth information along with image information.

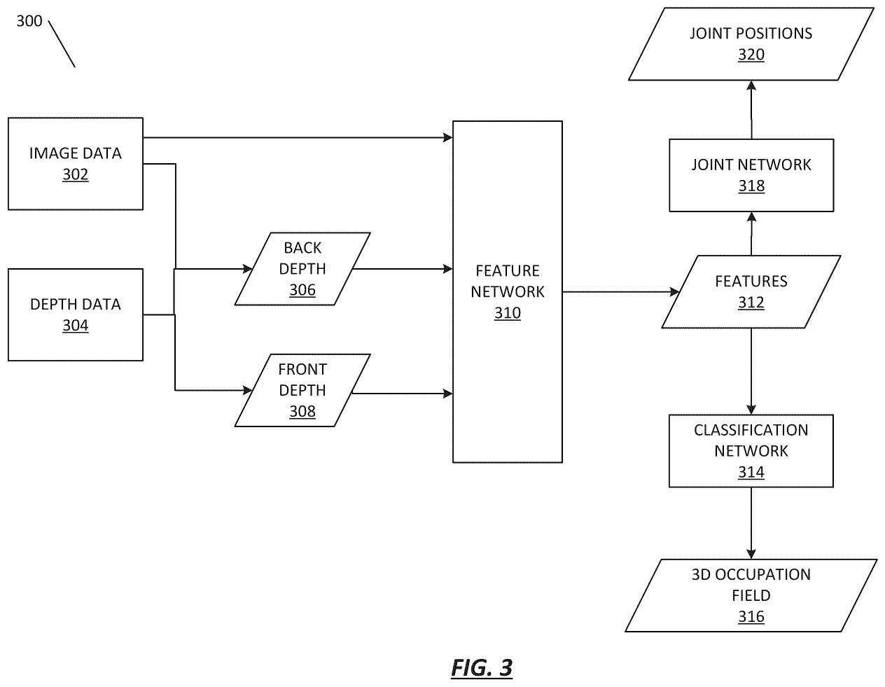

Optionally, at block 215, virtual representation of the subject is generated from the image and depth information. In some embodiments, the virtual representation data may include geometry information, texture information, and other information for the subject which can be used to drive the persona during runtime to present an accurate representation of the subject. For example, the virtual representation data may include a skeleton such as a series of joints which are used to drive the movement of the geometry of the virtual representation to provide an accurate representation of the movement of the subject. One example technique for generating the virtual representation data will be described in greater detail below with respect to FIG. 3.

The flowchart 200 continues at bock 220, where media content having the subject is accessed. That is, the image and/or depth data may be supplemented with additional data derived from DAs comprising the subject. Digital assets may be in the form of 2D or 3D image data, and may include or be stored with metadata indicative of context related to the image, such as people or objects detected in the image or otherwise identified as being present in the image. The DAs may be obtained from a variety of sources. For example, in different scenarios, DAs may be stored locally, at a server, or a combination thereof. Accordingly, the DAs may be processed locally to identify DAs having the subject. Alternatively, the DAs may be requested from a remote source such as a separate client device, a server, or the like. In some embodiments, the DAs having the subject may be obtained by requesting DAs having metadata “tagging” the subject, or otherwise indicating the subject is present in the DA. Alternatively, information relating to the identity of the subject, such as image data or features derived from the image data, may be used to perform facial recognition on the DAs to identify DAs having the subject.

At block 225, visual artifacts are extracted from the media content. Visual artifacts may include visual components of the subject in the DAs. This may include textural characteristics of the subject, such as skin tone, makeup, scars or lack of scars, or the like. As such, the visual artifact may include a 2D or 3D representation of the subject, or a portion of the subject based on one or more images comprising the subject or the portion of the subject. Other examples of digital artifacts include components having a geometry such as a hairstyle, headwear, or the like. Further, other examples include items associated with the user which can be used to build a virtual wardrobe, such as clothing, accessories, and the like. In some embodiments, the persona network can provide data about the subject to the visual artifact network to facilitate transforming the image data into the form of a texture or geometry. For example, using the geometric properties of the subject as generated by persona network at block 215, a visual artifact network can use one or more images having a particular accessory or characteristic to generate a texture of the accessory from the digital assets where the subject is wearing the accessory. According to one or more embodiments, the DAs used for generating accessories can be selected by a user. For example, a user may select a set of DAs having particular accessories, or which the user wants to be represented in the persona data.

Optionally, as shown at block 230, the visual artifact network 120 may additionally use the DAs to build a wardrobe or set of accessories which a user can use to supplement or further personalize the persona. Example accessories may include jewelry, clothing, hats or other headwear, scarves, or the like. For example, the visual artifact network 120 may use object detection in the subject digital assets to identify accessories, clothing items, or other objects which are shown to be worn frequently by the subject. The visual artifact network 120 may be trained to detect these items and generate subject accessories in a form that may be used to augment or supplement one or more subject personas. As an example, the persona accessories may be generated in the form of a texture to overlay a portion of the geometry of the virtual representation of the subject, a three dimensional component to replace or augment the geometry of the virtual representation of the person, or the like.

The flowchart concludes at block 235, where a virtual representation of the subject is generated using the virtual representation data and the extracted visual artifacts. In some embodiments, the virtual representation may be generated by using the virtual representation generated at optional step 215 and augmenting or modifying the virtual representation based on the visual artifacts, such as by replacing a portion of the virtual representation or enhancing the virtual representation using a generated persona accessory. Additionally, or alternatively, the visual artifacts may be fed into the persona network 110 to enhance generation of one or more personas. For example, a first persona may be generated using the enrollment data without regard to additional predefined DAs, whereas an alternative persona may be generated using the visual artifacts from the DAs.

FIG. 3 depicts an example flow diagram of a technique for generating virtual representation data during an enrollment process, in accordance with one or more embodiments. It should be understood that the example flow depicted in FIG. 3 is only one of various techniques which could be deployed to generate virtual representations of subjects in accordance with one or more embodiments.

The flow diagram 300 begins with input image data 302. The input image data 302 may be one or more images of a user or other subject. In some embodiments, the image 302 may be captured, for example, during an enrollment period in which a user utilizes a personal device to capture an image directed at the user's face or other body parts from which enrollment data may be derived for rendering virtual representation data associated with the subject. According to some embodiments, the image data 302 may be supplemented by image data obtained from DAs comprising the user, or data derived from the DAs comprising the user, such as visual artifacts generated from the DAs by visual artifact network 120.

In addition to the image 302, depth data 304 may be obtained corresponding to the image. That is, depth data 304 may be captured by one or more depth sensors which correspond to the subject in the image data 302. Additionally, or alternatively, the image 302 may be captured by a depth camera and the depth and image data may be concurrently captured. As such, the depth data 304 may indicate a relative depth of the surface of the subject from the point of view of the device capturing the image/sensor data. In some embodiments, DAs having the subject may include 3D image data from which depth data can be determined and used to supplement depth data 304.

According to one or more embodiments, the image data 302 may be applied to a feature network 310 to obtain a set of features 312 for the image data 302. The feature network 310 may additionally use back depth data 306 and front depth data 308. In some embodiments, front depth data 308 may be obtained from the depth data 304 and include depth information for a portion of the subject facing the sensors such as the depth sensors. Back depth 306 may be inferred or derived based on the captured depth data 304 and the image data 302. In one or more embodiments, the feature network 310 is configured to provide a feature vector for a given pixel in an image. A given sampled 3D point in space will have X, Y, and Z coordinates. From the X, Y coordinates, a feature vector is selected from among the features 312 of the images. In some embodiments, the feature network 310 may additionally use data from the DAs to determine features. For example, visual artifacts generated by the visual artifact network 120 may be used to generate the feature vectors.

In some embodiments each of the feature vectors are combined with the corresponding Z coordinate for the given sampled 3D point, to obtain feature vector 312 for the sampled 3D point at each image. According to one or more embodiments, the feature vector 312 may be applied to a classification network 314 to determine a classification value for the particular sampled 3D point for each input vector. For example, returning to the example image 302, for a given sampled 3D point, a classification value may be determined. In some embodiments, the classification network may be trained to predict a relation of a sampled point to the surface of the subject presented in the input image 302. For example, in some embodiments, the classification network 114 may return a value between 0-1, where 0.5 is considered to be on a surface, and 1 and 0 are considered to be inside and outside, respectively, the 3D volume of the subject delineated by the surface. Accordingly, for each sampled 3D point across the input images, a classification value is determined. A 3D occupation field 316 for the user can be derived from a combination of the classification values from the classification network 314. For example, the set of classification values may be analyzed to recover a surface of the 3D subject presented in the input image. In some embodiments, this 3D occupation field 316 may then be used for generating representations of the user, or part of the user, such as avatar representations of the user.

In addition to the 3D occupation field, joint locations for the user can be determined from the features 312. The joint network 318 may use the image data 302 as well as the depth information. The depth may include front depth data 308 and back depth data, either from back depth 306, or based on a back depth determined for the 3D occupation field 316 by the classification network 314. The joint network may be trained to predict joint positions 320 for the user in the image for which the 3D occupation field 316 is predicted.

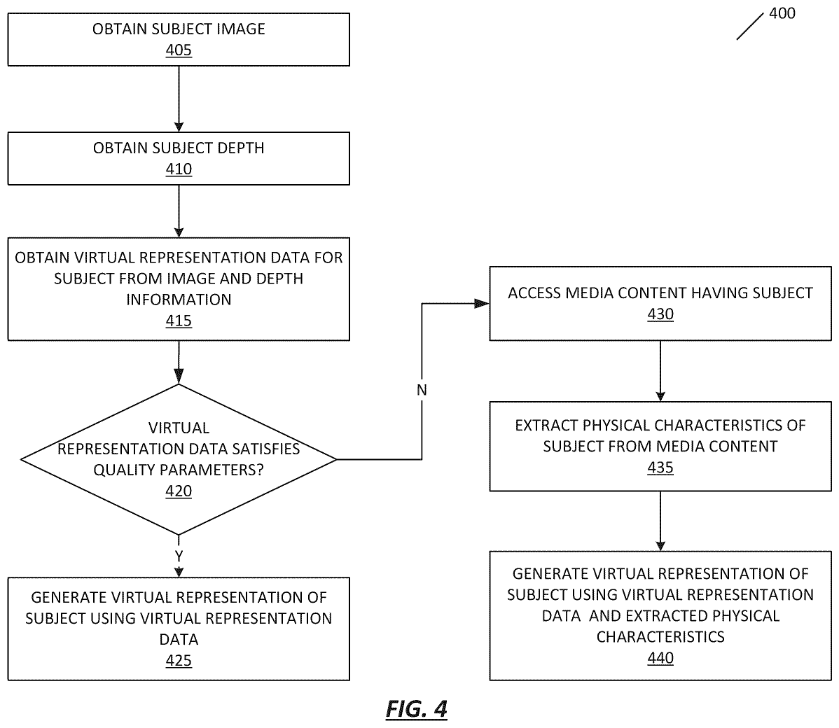

As described above, in some embodiments, the sensor data used to generate the virtual representation of the subject may be insufficient to generate an accurate representation of the subject. Accordingly, as shown in FIG. 4, some embodiments are directed to supplementing sensor data with content from DAs including the subject when a quality level of the sensor data is insufficient to generate an accurate representation of the subject. For purposes of explanation, the following steps will be described in the context of FIG. 1 and FIG. 3. However, it should be understood that the various actions may be performed by alternate components. In addition, the various actions may be performed in a different order. Further, some actions may be performed simultaneously, and some may not be required, or others may be added.

The flowchart 400 begins at block 405, where image data of the subject is obtained. In some embodiments, the image data may be captured, for example, during an enrollment period in which a user utilizes a personal device to capture an image directed at the user's face from which enrollment data may be derived for rendering avatar data associate with the user. In some embodiments, additional image data may be captured, such as of the subject's hands or arms. The image data may be captured by one or more cameras on a user device. For example, the user may enroll on a device that the user will use in an XR environment, such as a head mounted device. Alternatively, the subject may enroll on a separate device communicably connected to the head mounted device, such as a mobile device, desktop computer, or the like.

The flowchart continues to block 410, where depth data may be obtained corresponding to the images captured at 405. In some embodiments, depth sensor data may be captured by one or more depth sensors coincident with the images captured at block 405. The depth sensor data may indicate a relative depth of the surface of the subject from the point of view of the device capturing the image/sensor data. In some embodiments, the image data may include depth, or the depth may be derived from the image data. For example, multiple cameras, such as a stereo camera system, may be used to capture images of the subject, from which depth can be determined. As another example, the image data may be captured at least in part by a depth camera which provides depth information along with image information.

At block 415, virtual representation data is generated from the image and depth information. In some embodiments, the virtual representation data may include data from the sensor data from which geometry information, texture information, and other information for the subject can be derived, which can be used to drive the persona during runtime to present an accurate representation of the subject. In some embodiments, prior to generating the virtual representation of the user, one or more preprocessing steps may be performed, such as the determination of features 312, front depth 306, back depth 308, and the like.

The flowchart 400 proceeds to block 420, where a determination is made as to whether the virtual representation data of block 415 satisfies one or more quality parameters. For example, a portion of the user may not be well captured by the sensor data. The sensor data captured during enrollment may be analyzed to determine a health score or other quality parameters related to the quality of the data and the likelihood of the data generating an accurate representation of the subject. The quality parameters may therefore be predefined and used to compare the enrollment data to the health score or other metric to determine whether additional media content should be used to supplement the enrollment data. In some embodiments, quality parameters may be determined for different portions of the user/virtual representation such that DAs having those portions can be identified. For example, if a left side of a face is obfuscated in the enrollment data, DAs having the left side of the face visible may be selected. If a determination is made at block 420 that the virtual representation data, such as the enrollment data 100, satisfies one or more quality parameters, then the flowchart concludes at block 425 and the virtual representation of the subject is generated using the virtual representation data as captured during enrollment. The virtual representation data may be generated, for example, as described above with respect to FIG. 3 and without consideration of additional data from DAs comprising the subject. Additionally, in some embodiments, the resulting virtual representation data may be supplemented, augmented, or adjusted based on persona accessories, as described above with respect to FIG. 2.

Returning to block 420, if a determination is made that the virtual representation data, such as the enrollment data 100, fails to satisfy one or more quality parameters, then the flowchart proceeds to block 430 and media content having the subject is accessed. Digital assets in the form of 2D or 3D image data may be accessed, and may include or be stored with metadata indicative of context related to the image, such as people or objects detected in the image or otherwise identified as being present in the image. The digital assets may be obtained from a variety of sources. For example, in different scenarios, DAs may be stored locally, at a server, or a combination thereof. Accordingly, the DAs may be processed locally to identify DAs having the subject. Alternatively, the DAs may be requested from a remote source such as a separate client device, a server, or the like. In some embodiments, the DAs having the subject may be obtained by requesting DAs having metadata “tagging” the subject, or otherwise indicating the subject is present in the DA. Alternatively, information relating to the identity of the subject, such as image data or features derived from the image data, may be used to perform facial recognition on the DAs to identify DAs having the subject. In other embodiments, a user can select the DAs to be considered for generating the virtual representation

The flowchart 400 proceeds to block 435, where physical characteristics are extracted of the subject from the media content. The physical characteristics may be in the form of visual artifacts, and may be extracted by the visual artifact network 120. Visual artifacts may include visual components of the subject in the DAs. This may include textural characteristics of the subject, such as skin tone, makeup, scars or lack of scars, or the like. As such, the visual artifact may include a 2D or 3D representation of the subject, or a portion of the subject based on one or more images comprising the subject or the portion of the subject. Other examples of digital artifacts include components having a geometry such as a hairstyle, headwear, or the like. In some embodiments, the persona network can provide data about the subject to the visual artifact network to facilitate transforming the image data into the form of a texture or geometry. For example, using the geometric properties of the subject as generated by persona network at block 415, a visual artifact network can use one or more images having a particular characteristic to generate image or geometric data from which the persona network 110 can generate a virtual representation of the subject in the form of a persona.

The flowchart 400 concludes at block 440, where a virtual representation of the subject is generated using the virtual representation data from block 415, a well as the extracted physical characteristics from block 435. For example, the extracted physical characteristics, or data derived from the extracted physical characteristics, can be fed into the persona network to enhance generation of the virtual representation of the subject, as described above with respect to FIG. 3.

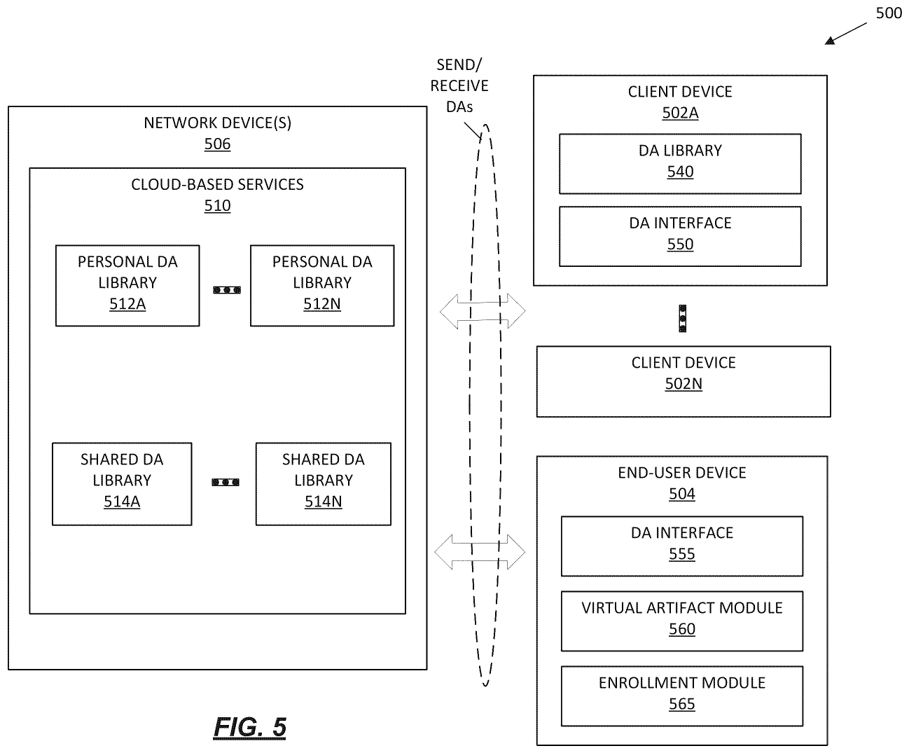

FIG. 5 illustrates, in block diagram form, a system 500 with networked end-user devices by which DAs can be generated, stored, and transferred, in accordance with an embodiment. In the system 500, the end-user devices 502A-502N include DA interfaces 550, from which DAs may be generated, for example by local cameras or other sensors, or obtained, for example from network device(s) 506, and may include a DA library in which DAs may be stored. End-user device 504 may be a device on which enrollment is performed. End-user device 504 may additionally include a DA interface 555 from which DAs may be generated, for example by local cameras or other sensors, or obtained, for example from network device(s) 506 or client devices 502A-502N. In some embodiments, end-user device 504 may include an enrollment module 565 which may use locally captured sensor data to enroll a user, and/or may use image data from DAs that are locally stored and/or remotely stored, for example in network device(s) 506 or client devices 502A-502N. Further, virtual artifact module 560 may be configured to generate virtual artifacts from the DAs which can be used by enrollment module 565, and/or can be used to generate persona accessories.

In the system 500, DAs may be sent and received between the end-user devices 502A-502N and end-user device 504 via network device(s) 506 and respective messaging or transmission applications. The network device(s) 506 include wired and/or wireless communication interfaces. In some example embodiments, the network device(s) 506 provide cloud storage and/or computing options for the end-user devices 502A-502N and end-user device 504, including storage of personal DA libraries 512A-512N and shared DA libraries 514A-514N. The personal DA libraries 512A-512N may be provided for particular end-user devices, or user profiles associated with end-user devices, and/or are available via subscription. Similarly, the shared DA libraries 514A-514N may be provided for particular end-user devices, or user profiles associated with end-user devices, and/or are available via subscription. Some of the DAs will be more meaningful to shared DA libraries, while others are less meaningful. For example, shared DA libraries 514A-514N may include libraries with DAs originating from client devices 502A-502N in which a user of end-user device 504 is tagged.

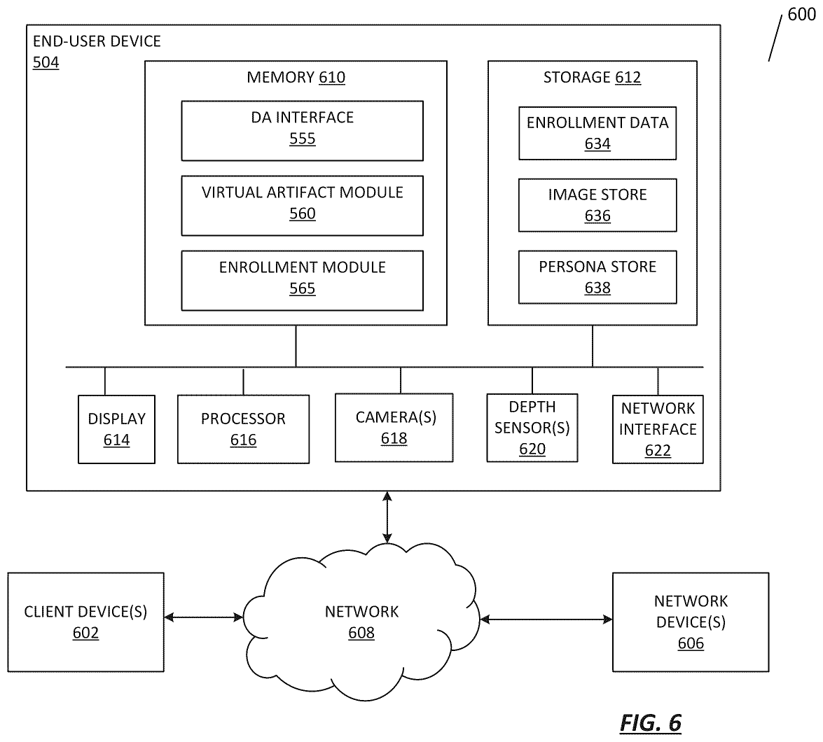

Referring to FIG. 6, an alternative simplified network diagram 600 including a the end-user device 504 is presented showing additional detail of the end-user device 504. The end-user device 504 may be utilized to generate a virtual representation of a subject, and may include an electronic device such as a phone, tablet computer, personal digital assistant, portable music/video player, wearable device, head mounted device, base station, laptop computer, desktop computer, mobile device, network device, or any other electronic device that has the ability to capture image data and generating virtual representations of a user.

End-user device 504 may include one or more processors 616, such as a central processing unit (CPU). Processor(s) 616 may include a system-on-chip such as those found in mobile devices and include one or more dedicated graphics processing units (GPUs) or other graphics hardware. Further, processor(s) 616 may include multiple processors of the same or different type. End-user device 504 may also include a memory 610. Memory 610 may include one or more different types of memory, which may be used for performing device functions in conjunction with processor(s) 616. Memory 610 may store various programming modules for execution by processor(s) 616, including DA interface 555, virtual artifact module 560, enrollment module 565, and potentially other various applications.

End-user device 504 may also include storage 612. Storage 612 may include enrollment data 634, which may include data regarding user-specific profile information, user-specific preferences, and the like. Enrollment data 634 may additionally include data used to generate avatars specific to the user, such as a 3D mesh representation of the user, join locations for the user, a skeleton for the user, and the like. Storage 612 may also include an image store 636. Image store 636 may be used to store a series of images from which enrollment data can be determined, such as the input images described above from which three-dimensional information can be determined for a subject in the images. In addition, image store 636 may include additional DAs, for example in the form of a DA library. Storage 612 may also include an persona store 638, which may store data used to generate virtual representations of a subject, such as geometric data, texture data, predefined personae, and the like. In addition, persona store 638 may include a persona accessory library in which persona accessories generated by the virtual artifact module 560 are stored.

In some embodiments, the end-user device 504 may include other components utilized for persona enrollment, such as one or more cameras 618 and/or other sensors, such as one or more depth sensor(s) 620. In one or more embodiments, each of the one or more cameras 618 may be a traditional RGB camera, a depth camera, or the like. The one or more cameras 618 may capture input images of a subject for determining 3D information from 2D images. Further, cameras 618 may include a stereo or other multicamera system.

Although client device 602 is depicted as comprising the numerous components described above, and one or more embodiments, the various components and functionality of the components may be distributed differently across one or more additional devices, for example across a network. For example, in some embodiments, any combination of storage 612 may be partially or fully deployed on additional devices, such as network device(s) 606, or the like. Further, the various components of end-user device may be configured to access DAs or other data or functionality from other devices, such as client device(s) 602, and network device(s) 606 across network 608, for example using network interface 622.

According to one or more embodiments, the end-user device may include a display 614 which can be used to facilitate the enrollment process. For example, a preview of the personae, persona accessories, or the like can be presented to the user on the display 614. There are many different types of electronic systems that enable a person to sense and/or interact with various XR environments. Examples include: head-mountable systems, projection-based systems, heads-up displays (HUD), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mountable system may have one or more speaker(s) and an integrated opaque display. Alternatively, a head-mountable system may be configured to accept an external opaque display (e.g., a smartphone). The head-mountable system may incorporate one or more imaging sensors to capture images or video of the physical environment, and/or one or more microphones to capture audio of the physical environment. Rather than an opaque display, a head-mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram, or on a physical surface.

Further, in one or more embodiments, end-user device 504 may be comprised of multiple devices in the form of an electronic system. For example, input images may be captured from cameras on accessory devices communicably connected to the client device 602 across network 608, or a local network As another example, some or all of the computational functions described as being performed by computer code in memory 610 may be offloaded to an accessory device communicably coupled to the client device 602, a network device such as a server, or the like. Accordingly, although certain calls and transmissions are described herein with respect to the particular systems as depicted, in one or more embodiments, the various calls and transmissions may be differently directed based on the differently distributed functionality. Further, additional components may be used, or some combination of the functionality of any of the components may be combined.

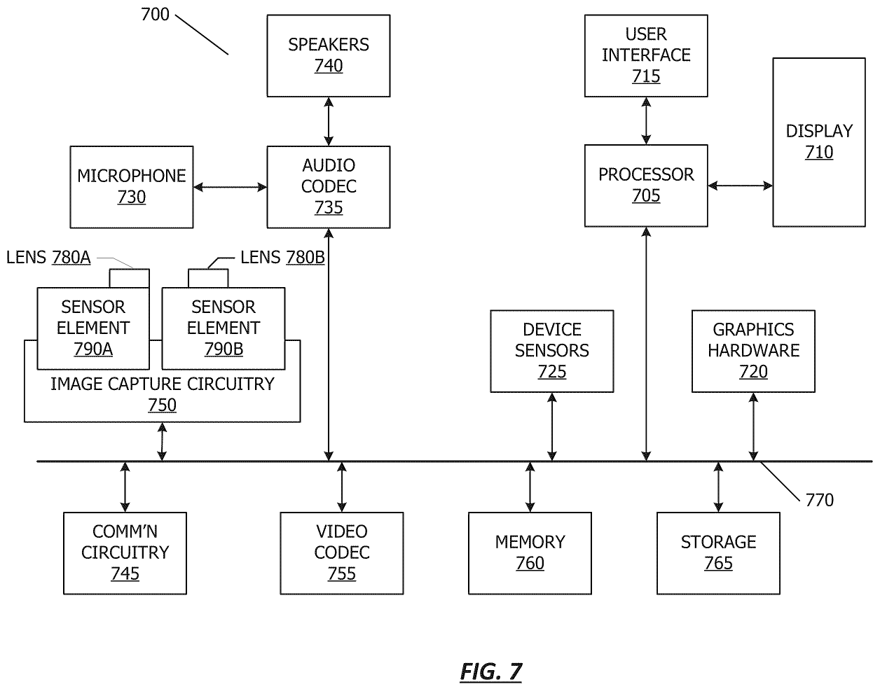

Referring now to FIG. 7, a simplified functional block diagram of illustrative multifunction electronic device 700 is shown according to one embodiment. Each of the electronic devices may be a multifunctional electronic device or may have some or all of the described components of a multifunctional electronic device described herein. Multifunction electronic device 700 may include some combination of processor 705, display 710, user interface 715, graphics hardware 720, device sensors 725 (e.g., proximity sensor/ambient light sensor, accelerometer and/or gyroscope), microphone 730, audio codec 735, speaker(s) 740, communications circuitry 745, digital image capture circuitry 750 (e.g., including camera system), memory 760, storage device 765, and communications bus 770. Multifunction electronic device 700 may be, for example, a mobile telephone, personal music player, wearable device, tablet computer, and the like.

Processor 705 may execute instructions necessary to carry out or control the operation of many functions performed by device 700. Processor 705 may, for instance, drive display 710 and receive user input from user interface 715. User interface 715 may allow a user to interact with device 700. For example, user interface 715 can take a variety of forms, such as a button, keypad, dial, a click wheel, keyboard, display screen, touch screen, and the like. Processor 705 may also, for example, be a system-on-chip such as those found in mobile devices and include a dedicated GPU. Processor 705 may be based on reduced instruction-set computer (RISC) or complex instruction-set computer (CISC) architectures or any other suitable architecture and may include one or more processing cores. Graphics hardware 720 may be special purpose computational hardware for processing graphics and/or assisting processor 705 to process graphics information. In one embodiment, graphics hardware 720 may include a programmable GPU.

Image capture circuitry 750 may include one or more lens assemblies, such as 780A and 780B. The lens assemblies may have a combination of various characteristics, such as differing focal length and the like. For example, lens assembly 780A may have a short focal length relative to the focal length of lens assembly 780B. Each lens assembly may have a separate associated sensor element 790. Alternatively, two or more lens assemblies may share a common sensor element. Image capture circuitry 750 may capture still images, video images, enhanced images, and the like. Output from image capture circuitry 750 may be processed, at least in part, by video codec(s) 755 and/or processor 705, and/or graphics hardware 720, and/or a dedicated image processing unit or pipeline incorporated within circuitry 745. Images so captured may be stored in memory 760 and/or storage 765.

Memory 760 may include one or more different types of media used by processor 705 and graphics hardware 720 to perform device functions. For example, memory 760 may include memory cache, read-only memory (ROM), and/or random access memory (RAM). Storage 765 may store media (e.g., audio, image and video files), computer program instructions or software, preference information, device profile information, and any other suitable data. Storage 765 may include one more non-transitory computer-readable storage mediums, including, for example, magnetic disks (fixed, floppy, and removable) and tape, optical media such as CD-ROMs and digital video discs (DVDs), and semiconductor memory devices such as Electrically Programmable Read-Only Memory (EPROM), and Electrically Erasable Programmable Read-Only Memory (EEPROM). Memory 760 and storage 765 may be used to tangibly retain computer program instructions or computer readable code organized into one or more modules and written in any desired computer programming language. When executed by, for example, processor 705, such computer program code may implement one or more of the methods described herein.

A physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an XR environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

It is to be understood that the above description is intended to be illustrative and not restrictive. The material has been presented to enable any person skilled in the art to make and use the disclosed subject matter as claimed and is provided in the context of particular embodiments, variations of which will be readily apparent to those skilled in the art (e.g., some of the disclosed embodiments may be used in combination with each other). Accordingly, the specific arrangement of steps or actions shown in FIGS. 1-4 or the arrangement of elements shown in FIGS. 5-7 should not be construed as limiting the scope of the disclosed subject matter. The scope of the invention therefore should be determined with reference to the appended claims, along with the full scope of equivalents to which such claims are entitled. In the appended claims, the terms “including” and “in which” are used as the plain English equivalents of the respective terms “comprising” and “wherein.”

1. A non-transitory computer readable medium comprising computer readable code executable by one or more processors to:
obtain, at a local device, sensor data of a subject;
obtain media assets comprising the subject from a digital asset library;
generate a visual artifact for the subject based on the media assets; and
generate, by the local device, a virtual representation of the subject using the sensor data and the visual artifact.

2. The non-transitory computer readable medium of claim 1, wherein the computer readable code to generate a visual artifact for the subject based on the media assets further comprising computer readable code to:
extract, from the media assets having the subject, image data comprising a subject accessory;
apply the image data comprising the subject accessory to a network trained to generate a texture corresponding to the subject accessory to obtain a subject accessory component; and
generate an accessory library for subject comprising the subject accessory component.

3. The non-transitory computer readable medium of claim 2, wherein the subject accessory component comprises a subject accessory texture, and wherein the computer readable code to generate the one or more virtual representations of the subject comprises computer readable code to:
apply the subject accessory texture to at least a portion of one of the one or more virtual representations of the subject.

4. The non-transitory computer readable medium of claim 2, wherein the one or more virtual representations generated using the sensor data and the subject accessory component are provided as one or more alternative virtual representations of the subject.

5. The non-transitory computer readable medium of claim 2, wherein the computer readable code to generate the one or more virtual representations of the subject comprises computer readable code to:
generate an initial virtual representation using the sensor data; and
augment the initial virtual representation with the subject accessory component.

6. The non-transitory computer readable medium of claim 2, wherein the subject accessory component comprise a three-dimensional hair style component.

7. The non-transitory computer readable medium of claim 1, wherein the media assets comprising the subject are obtained from a digital asset library in accordance with a determination that the sensor data fails to satisfy one or more quality parameters.

8. A method comprising:
obtaining, at a local device, sensor data of a subject;
obtaining media assets comprising the subject from a digital asset library;
generating a visual artifact for the subject based on the media assets; and
generating, by the local device, one or more virtual representations of the subject using the sensor data and the visual artifact.

9. The method of claim 8, wherein obtaining sensor data of the subject comprises:
determining geometric characteristics of the subject and texture characteristics of the subject based on the sensor data.

10. The method of claim 8, wherein identifying media assets comprising the subject comprises:
requesting one or more media items from the digital asset library associated with the subject.

11. The method of claim 8, wherein generating a visual artifact for the subject based on the media assets further comprising:
extracting, from the media assets having the subject, image data comprising a subject accessory;
applying the image data comprising the subject accessory to a network trained to generate a texture corresponding to the subject accessory to obtain a subject accessory component; and
generating an accessory library for subject comprising the subject accessory component.

12. The method of claim 11, wherein the subject accessory component comprises a subject accessory texture, and wherein generating the one or more virtual representations of the subject comprises:
applying the subject accessory texture to at least a portion of one of the one or more virtual representations of the subject.

13. The method of claim 11, wherein the one or more virtual representations generated using the sensor data and the subject accessory component are provided as an alternative one or more virtual representations of the subject.

14. The method of claim 11, wherein generating the one or more virtual representations of the subject comprises:
generating an initial virtual representation using the sensor data; and
augmenting the initial virtual representation with the subject accessory component.

15. The method of claim 11, wherein the subject accessory component comprise a three-dimensional hair style component.

16. A system comprising:
one or more processors; and
one or more computer readable media comprising computer readable code executable by the one or more processors to:
obtain, at a local device, sensor data of a subject;
obtain media assets comprising the subject from a digital asset library;
generate a visual artifact for the subject based on the media assets; and
generate, by the local device, one or more virtual representations of the subject using the sensor data and the visual artifact.

17. The system of claim 16, wherein the computer readable code to obtain sensor data of the subject comprises computer readable code to:
determine geometric characteristics of the subject and texture characteristics of the subject based on the sensor data.

18. The system of claim 16, wherein the computer readable code to identify media assets comprising the subject comprises computer readable code to:
request one or more media items from the digital asset library associated with the subject.

19. The system of claim 16, wherein the computer readable code to generate a visual artifact for the subject based on the media assets further comprising computer readable code to:
extract, from the media assets having the subject, image data comprising a subject accessory;
apply the image data comprising the subject accessory to a network trained to generate a texture corresponding to the subject accessory to obtain a subject accessory component; and
generate an accessory library for subject comprising the subject accessory component.

20. The system of claim 16, wherein the media assets comprising the subject are obtained from a digital asset library in accordance with a determination that the sensor data fails to satisfy one or more quality parameters.
